(19) United States
(12) Patent Application Publication
(10) Pub. No.: US 2021/0283922 A1
(43) Pub. Date: Sep. 16, 2021

(54) INK RECYCLING IN A TEXTILE PRINTER

(71) Applicant: Kornit Digital Ltd., Rosh HaAyin (IL)

(72) Inventors: David TULIPMAN, Tel Aviv (IL); Jacob MANN, Zoran (IL); Tomer-Pinhas ARTZI, Nes-Ziona (IL); Ilan Shmuel MANO, Ramat-Gan (IL)

(73) Assignee: Kornit Digital Ltd., Rosh HaAyin (IL)

(21) Appl. No.: 17/255,509

(22) PCT Filed: Jun. 27, 2019
(86) PCT No.: PCT/IL2019/050715

§ 371 Date: Dec. 23, 2020

Related U.S. Application Data
(60) Provisional application No. 62/690,362, filed on Jun. 27, 2018.

(51) Int. Cl. B41J 2/185; B41J 2/165; B41J 2/21; B41J 2/175; B41J 3/407

(52) U.S. Cl. CPC B41J 2/185; B41J 2/16523; B41J 2002/1856; B41J 2/17566; B41J 3/4078; B41J 2/2103

(57) ABSTRACT

A method of recycling ink used in non-printing nozzle dispensing operations in an ink jet printer, comprises collecting the ink from the non-printing operation in a collection tray, draining the ink from the collection tray into a closed cell, draining the ink from the closed cell, filtering the ink draining from the closed cell, and adding the ink back to a main ink supply after filtering, the main ink supply containing fresh ink. To maintain the quality of the ink supply the proportion of recycled to fresh ink may be limited to a maximum.

### RELATED APPLICATION

This application claims the benefit of priority of U.S. Provisional Patent Application No. 62/690,362 filed on Jun. 27, 2018, the contents of which are incorporated herein by reference in their entirety.

### FIELD AND BACKGROUND OF THE INVENTION

The present invention, in some embodiments thereof, relates to ink recycling in a textile printer and, more particularly, but not exclusively, to ink recycling where it is necessary to keep printing nozzles wet at all times, even when the printer is not being used, so as to avoid blockages and other occlusions due to ink drying and the like.

In inkjet printing in general and in particular with textile printing, it is required to maintain the state of the printhead nozzles, and such maintenance entails keeping the nozzles clean, in particular in respect of clogging and any other kind of interference that may affect the formation and actuation of the ink jet. Clogging of the nozzles may occur for various different reasons, among them drying of the ink and particle sedimentation.

There are a few known methods to prevent clogging of the nozzles and one widely used and reliable method involves regular jetting of ink through the print heads in non-printing sequences during intervals between printings. Such a method ensures that the print heads remain wet and are regularly cleared or purged.

The jetted ink in such non -printing-operation situations is treated as waste since it has been exposed to the open environment of the printer and is thus liable to pick up dirt, including fibers and dust. Furthermore there may be color contamination due to contact with other ink colors. In addition, the ink may have been impacted by the print head temperature, which may have changed some of its physical properties, such as concentration, pH (acidity level), and viscosity. Furthermore the ink may be become diluted due to the ink droplets picking up moisture from the surrounding air. For those reasons the ink used in the purging or other non-printing processes is not returned to the ink reservoir, since it would degrade the ink supply as a whole.

The Hydra Ink Supply System is known in the prior art and is a recirculating ink supply system for industrial printers, in which recovered ink from purging and the like is recirculated. The supply system is part of a bulk ink system so it is part of the ink supply and not of the printing machine. The recycled ink may be shared by printers and there is no closed loop system created with the original printer. The ink may be contaminated due to exposure to the external environment, and there is no reference to the physical change of the ink properties, so the Hydra system may only be used for short stoppage intervals, say while the garment is changed. If used for long intervals the result is degradation of the ink so that the Hydra system is not useful over a break the length of a weekend.

### SUMMARY OF THE INVENTION

The present embodiments relate to a process of recycling ink excess used by a direct to garment printer. The recycle system collects injected ink used in the print heads but which is not used to actually print on the fabric, and then treats the collected ink as will be discussed below to put it back into a usable state for return to the ink delivery system and continued use within the printer.

As well as treatment, the proportion of recycled ink to unused ink may be controlled. Using the present embodiments the nozzles may be maintained throughout and the ink not used for printing is recycled but in a way that minimizes degradation of the ink supply. The ink which now includes the recycled ink along with fresh ink may then be utilized for printing on the fabric.

According to an aspect of some embodiments of the present invention there is provided a method of recycling ink used in non-printing nozzle dispensing operations in an ink jet printer, the method comprising:

collecting the ink from the non-printing operation in a collection tray;

draining the ink from the collection tray into a closed cell;

draining the ink from the closed cell;

filtering the ink draining from the closed cell; and

adding the ink back to a main ink supply after the filtering, the main ink supply containing fresh ink.

In an embodiment, a proportion of collected ink to fresh ink in the main ink supply is limited to a predetermined maximum proportion, the adding ink back being suspended when the predetermined maximum proportion is reached.

In an embodiment, the recycling is carried out separately per color, each color being assigned a respectively separate closed cell and the ink being added back to the main ink supply of the respective color.

Embodiments may comprise carrying out the filtering to remove environmental dirt from the ink being collected.

In an embodiment, the filtering comprises separate coarse and fine filtering on the ink being collected.

Embodiments may comprise buffering the ink being collected.

In an embodiment, the buffering is carried out between the coarse filtering and the fine filtering.

In an embodiment, the cell is substantially closed to protect the collected ink from environmental contaminants.

According to a second aspect of the present invention there is provided a method of recycling ink used in non-printing nozzle dispensing operations in an ink jet printer, the method comprising:

collecting the ink from the non-printing operation in a cell of a collection tray;

draining the ink from the cell;

filtering the ink draining from the cell;

adding the collected ink, after the filtering, back to a main ink supply containing fresh ink; and

stopping adding the collected ink back to the main ink supply when a proportion of collected ink to fresh ink reaches a predetermined maximum proportion.

According to a third aspect of the present invention there is provided apparatus for recycling ink used in non-printing nozzle dispensing operations in an ink jet printer, the apparatus comprising:

a collection tray configured with closed cells configured to collect individual ink colors from the non-printing nozzle dispensing operations;

a filtering system, the cells arranged to drain into the filtering system;

the filtering system arranged to filter the ink per color and return the collected ink to an internal tank for a respective color.

In embodiments, a base of the collection tray and surfaces of the closed cells are constructed or coated using one or more substances selected to be non-reactive with the ink and/or for aiding fast flow of the collected ink.

In embodiments, at least one of the substances is polyoxymethylene.

In embodiments, at least one of the substances is polytetrafluoroethylene (PTFE).

In embodiments, the ink collection tray comprises polyoxymethylene and the surfaces of the closed cells are coated with PTFE.

Embodiments may comprise an override to redirect ink from the non-printing operation being collected.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the control systems in embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flow chart illustrating ink recycling according to a first embodiment of the present invention;

FIG. 2 is a simplified flow chart illustrating ink recycling according to a variation of the embodiment of FIG. 1;

FIG. 3 is a simplified block diagram of an ink recycling circuit according to embodiments of the present invention;

FIG. 4A is a simplified diagram of an ink collecting tray in an open state, according to embodiments of the present invention;

FIG. 4B is a simplified diagram of the ink collecting tray of FIG. 4A in a closed state, according to embodiments of the present invention; and

FIG. 5 is a simplified flow chart of an ink recycling management process according to embodiments of the present invention.

### DESCRIPTION OF SPECIFIC EMBODIMENTS OF THE INVENTION

The present invention, in some embodiments thereof, relates to ink recycling in a textile printer and, more particularly, but not exclusively, to ink recycling where printing nozzles are kept wet at all times, even when the printer is not being used, to prevent clogging and like problems.

The present embodiments may enable one or more treatments to ink that is injected through the print nozzles but is not used for true printing on fabric. The treatment may enable recycling and re-use for actual printing on the fabric in a way that does not degrade the ink supply, at least not to a noticeable extent.

The recovery of the ink may be achieved by the following:
a. Minimal exposure to the printer environment. Thus, as soon as the ink is jetted, it may be removed quickly to the internal tanks rather than stay for any length of time in the separation trays, thus preventing as much contamination as possible;
b. Dilution with the fresh ink not to exceed a preset ratio; and
c. Carrying out nozzle clearing operations one color at a time with an interval in between that is sufficiently long for ink to dry, so that unintended color contamination is avoided.

The amount of ink saving can vary significantly as it may depend on the operation mode of the printer. Thus savings may be large in a printer regularly left unused over nights and weekends, and much smaller in an identical printer used in a factory which has night and weekend shifts. The waste in some printers in some cases may reach 35%-40% and in others may be very little and the ink saved by recycling may vary accordingly.

Embodiments entail separation of the injected ink. From the print head, the injected ink from the non-productive events may be directed to separate cells, so that each color ink may have its own separate cell. The cell may prevent the different ink colors from mixing and may also serve to prevent or significantly reduce the exposure of the ink to the open environment of the printer, to prevent contamination by dust, fibers, gases etc.

All components which are in contact with the jetted ink may be constructed from materials that prevent corrosion or reaction of other kinds with the ink.

The ink in the separation cells may be subject to internal humidity control to allow the ink to recover from the impact of the print head temperature.

The ink from the separation cells may be directed to an intermediate container, where dedicated volume may be made available for each ink color. Thus the ink may be drained quickly, and as soon as, or practically as soon as it is jetted.

Each ink color may be delivered back independently to the printer ink supply system. Resupply may be to the original ink supply container, to an external ink container and/or to an internal ink container, of the given color.

The ink may be filtered for particles and other contaminants prior to delivery back. A dilution ratio maximum of say 1:5 of recycled ink to fresh ink may be observed, so that once the maximum is reached, no further ink is recycled for that color until further printing is carried out. A limit to the maximum proportion of recycled ink may help to ensure that any chemical changes in the recycled ink due to jetting are present only in a diluted way in the ink supply.

The ink recycling may be available for a specific printer and as well for multi-printer arrangements.

An option may be provided to bypass the ink recycling. Such a bypass may be mechanical and/or may be software controlled, so that the system is self-sustained in its state machine and is able to prevent any kinds of mixtures from being made that would compromise the ink supply. The bypass may be operated when fluids other than inks are used on the printer, say cleaning fluids, and ensures that it is possible to separate the clean ink from any other fluids. Accordingly, in cases of malfunctioning or when jetting of ink or cleanser liquids is required for non-printing events, non-ink liquids or contaminated ink may be directed by the bypass facility to a separate waste tank so as not be included in the ink cycle.

Separation of the ink to be recycled as quickly and as thoroughly as possible from exposure to the printer environment may prevent contamination of the ink while maintaining print head reliability, printing consistency and quality, despite the fact that some of the ink is recycled.

As discussed, the embodiments may take into account changes in the physical properties of the inks caused by passing through the print heads, and may control these changes before returning the ink to the ink delivery system. Controlling the recycled ink properties may help to maintain the consistency of the ink and thus maintain print head stability and reliability and hence print quality. Thus the ink recycling need not impact print matching, so that similarity between results of the same print job carried out at different printers may be maintained.

As explained, a bypass of the recycling system may be provided to enable safe maintenance activities and prevent ink contamination through these activities.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

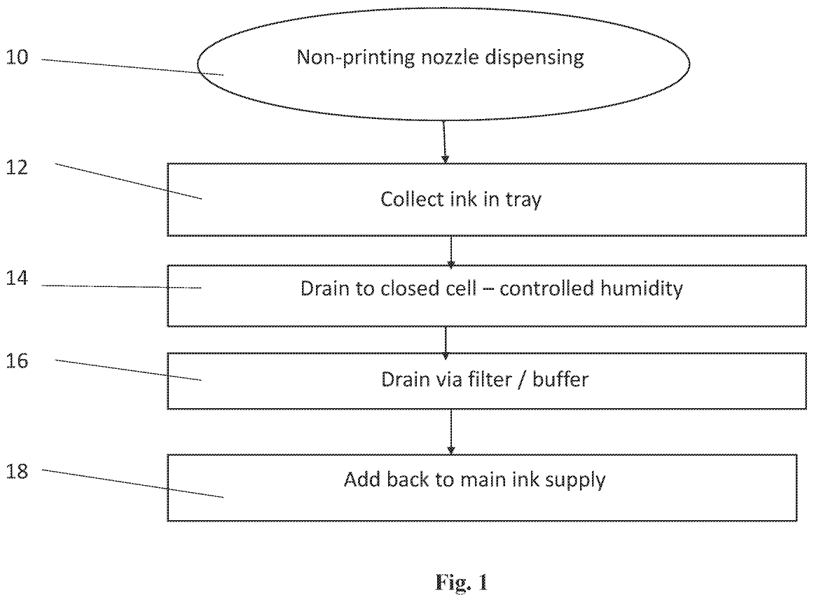

Referring now to the drawings, FIG. 1 is a simplified flow chart that illustrates a first embodiment of the present invention. When the printer is not actually being used for printing, the nozzles are liable to become blocked if not regularly purged. Thus nozzle dispensing operations are carried out at regular intervals 10. In the nozzle dispensing operations, ink is jetted from the nozzles, however there is no textile for the ink to hit so instead the ink is collected in a collection tray—12. In general the operation is carried out per color so that there is no mixing of ink of different colors. The ink in the collection tray is then drained into a closed cell—14. The cell is closed so that the collected ink is as isolated as possible from the environment and from external levels of humidity which may serve to dilute the ink, especially when in droplet form. Both the tray and the cell are made of materials which are chosen to allow the ink to drain fast with minimal interaction, as will be discussed in greater detail below.

The ink is then drained from the cell into a filtering and buffering arrangement—16—where the ink is filtered for any dust or fibers that may have got into the ink. In embodiments there may be separate coarse and fine filters with a buffer tank in between. Then the ink is added back—18—to the main ink supply. Isolation in the closed cell combined with filtering the ink before replacement may ensure the quality of the ink in the main supply.

An additional feature to ensure that the quality of the ink in the main supply is to limit the amount of replaced ink. That is the proportion of collected ink to fresh ink in the main ink supply may be limited to a preset maximum proportion, for example one fifth. Alternatively the maximum proportion may be a tenth or a ninth or an eighth or a seventh or a sixth or a fifth or a quarter or a third. The process of adding ink back may be suspended when the predetermined maximum proportion is reached. One way of achieving limiting of the proportion is to measure the amount of ink in the main supply at the beginning of the non-printing nozzle operation and then again at regular intervals during the period that the printer is unused and only non-printing operations are carried out. Once the preset proportion is reached then the adding back procedure may be suspended.

In embodiments, ink recycling is carried out separately for each color. That is the nozzle dispensing operations are carried out one color at a time and separate closed cells are provided for each color. The ink is added back to the main ink supply of the respective color after filtering, and typically a separate filtering path is provided for each color. In this way the ink that is replaced in the main ink supply is not contaminated with the other colors. Furthermore, the surface of the ink collecting tray may be made to repel ink so that the ink drains rapidly from the tray before the next color appears.

In textile printing locations, often a shop or a factory, there are often considerable quantities of environmental contaminants, so that even with a very brief appearance of the ink in the external environment, contamination with dust and fibers is likely. The filtering part of the process is intended to remove all such environmental dirt from the ink being collected. Filtering is combined with efforts to ensure that the amount of time that the ink is in the external environment is kept to the minimum possible. Namely the period of time between being jetted from the nozzle and draining into the closed cell is kept as short as possible.

As mentioned, filtering may comprise separate coarse and fine filtering on the ink being collected. Buffering may be carried out on the ink being collected, and inter alia may ensure that the fine filter is not overwhelmed. The buffering may be carried out between the coarse filtering and the fine filtering by placing a buffering tank between the two filters.

The cell itself is a substantially closed container to protect the collected ink from environmental contaminants, and the collection tray and cells may be designed together to take the ink back into the internal environment of the printer as quickly as possible after jetting. The cell may have an input passageway to receive ink from the collecting tray and an output passageway for ink to drain to the next stage.

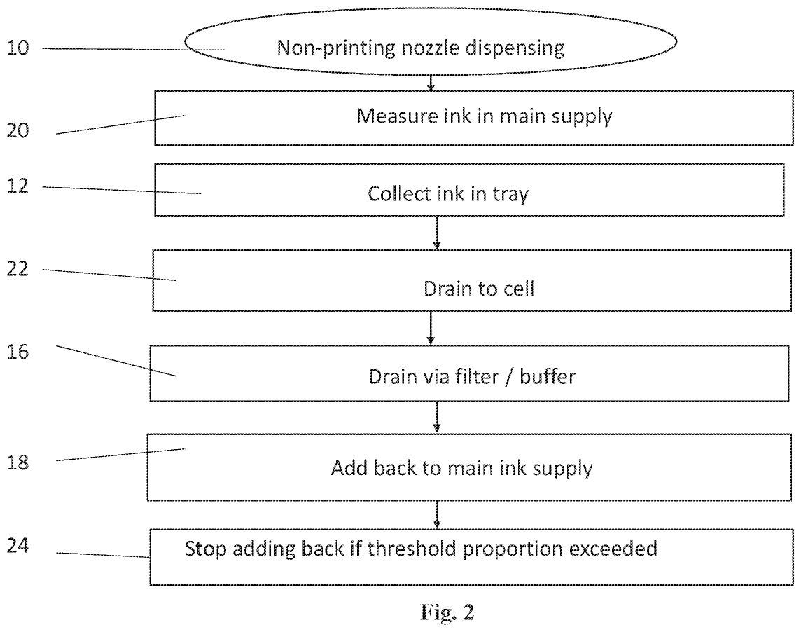

Reference is now made to FIG. 2, which is a simplified diagram of a variation of the embodiment of FIG. 1 in which the ink from the non-printing operation is collected in a cell that opens out from a collection tray. Procedural parts that are the same as in FIG. 1 are given the same reference numerals.

As before the printer is currently not being used for printing but the nozzles are liable to become blocked if not regularly purged. Thus nozzle dispensing operations are carried out at regular intervals—10. Prior to collecting any ink, the amount of ink in the main supply may be measured—20. As before, in the nozzle dispensing operations, ink is jetted from the nozzles however there is no textile for the ink to hit so instead the ink is collected in a collection tray—12. In general the operation is carried out per color so that there is no mixing of ink of different colors. The ink in the collection tray is then drained into a cell—22. Both the tray and the cell are made of materials which are chosen to allow the ink to drain fast with minimal interaction, as will be discussed in greater detail below.

The ink is drained from the cell into a filtering and buffering arrangement—16—where the ink is filtered for any dust or fibers that may have got into the ink. As before, there may be separate coarse and fine filters with a buffer tank in between.

Then the ink is added back—18—to the main ink supply.

Using the initial measurement obtained in box 20 and comparing it with subsequent measurements, the total amount of replaced ink may be tracked. In order to ensure that the quality of the ink in the main supply is not compromised a limit may be set on the maximum amount of replaced ink as a proportion of the original fresh ink, as discussed above. That is the proportion of collected ink to fresh ink in the main ink supply may be limited to a preset maximum proportion, and exemplary proportions are discussed hereinabove. The process of adding ink back may be suspended when the predetermined maximum proportion is reached—24. One way of limiting the proportion is to use the measurement of the amount of ink in the main supply at the beginning of the non-printing nozzle operation and compare with later measurements taken at regular intervals during the period that the printer is unused and only non-printing operations are carried out. Once the newest measurement compared with the original measurement indicates that the preset proportion is reached then the adding back procedure may be suspended.

As before, in the present embodiment, ink recycling is carried out separately for each color. That is the nozzle dispensing operations are carried out one color at a time and separate closed cells are provided for each color. The ink is added back to the main ink supply of the respective color after filtering, and typically a separate filtering path is provided for each color. In this way the ink that is replaced in the main ink supply is not contaminated with the other colors. Furthermore, the surface of the ink collecting tray may be made to repel ink so that the ink drains rapidly from the tray before the next color appears.

In both the cases of FIG. 1 and FIG. 2, an override switch may be added to override the ink reuse system as a whole. For example an override valve may redirect the supply from the collection tray or the cells directly to a waste collector tank. The override may be manual or software operated. One example of using the override is during operations where cleaning fluid is used, so that the liquid getting into the collection tray is not in fact ink.

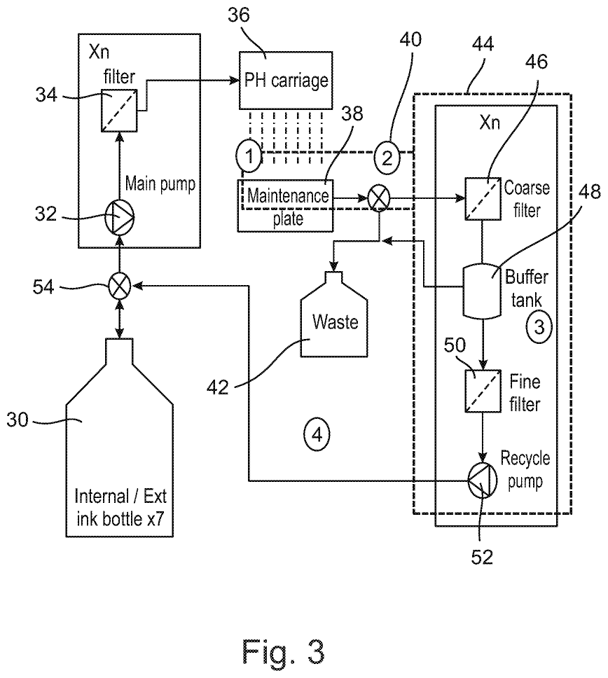

Reference is now made to FIG. 3, which is a simplified block diagram of ink recycling apparatus for a textile printer according to embodiments of the present invention. The apparatus is for recycling ink used in non-printing nozzle dispensing operations in the ink jet textile printer. The diagram may be per color. For each color, a main ink supply 30 holds the supply of ink. The ink is pumped via main pump 32 and main filter 34 to print head carriage 36 from which it is fed to the nozzles and expelled as ink jet droplets. The droplets are collected in collection tray 38 which is a maintenance plate having dedicated internal cells for each color, non-reactive or minimally reactive surfaces and short drainage time. The ink collected by the tray drains into the cell set aside for the respective color.

Valve 40 is controlled by the override system, so that all the ink or other liquids collected may be directed to the waste collector 42. As mentioned above, the override is useful during maintenance operations where liquids other than inks are used.

In the event that the override is not operated then valve 40 directs flow to filter section 44. Filter section 44 filters the ink prior to recycling and includes coarse filter 46, buffer tank 48 and fine filter 50. Recycle pump 52 directs the liquid from the filter section 44, to valve 54 which drains the ink back into the main ink supply 30.

Buffer tank 48 is additionally connected to waste collector 42 for direct disposal when recycling is not possible.

As discussed, the base of the collection tray and surfaces of the closed cells are constructed or coated using substances selected to be non-reactive with the ink and/or for aiding fast flow of the collected ink.

In embodiments there may be two substances, one used for the base of the tray and one used for wall of the cell. One of the substances may be polyoxymethylene, and the other substance may be polytetrafluoroethylene (PTFE).

In embodiments the ink collection tray comprises polyoxymethylene and the surfaces of the closed cells are coated with PTFE.

More particularly, the base of the ink collection tray may be made using any commercially available variant of polyoxymethylene, for example Delrin™ Celcon™ Ramtal™, Duracon™ Kepital™ and Hostaform™.

The cells, that is the ink collection chambers of the collection tray 38, may be coated with polytetrafluoroethylene (PTFE) for example in the form of commercially available Teflon™ sticker.

Sensors may be provided in association with the main ink supply containers for sensing amounts of ink. Sensing may involve visible sensing of an ink level, or weighing of the container or any other suitable method.

A control system may control the sensors to measure an initial amount of ink prior to the non-printing operation and to make further measurements at subsequent intervals. Then the control system uses the first and at least the most recent measurements to limit a proportion of collected ink allowed into each internal tank. Thus the amount of recycled ink is limited to a predetermined maximum proportion.

As discussed, valve 44 provides an override to redirect ink and override the recycling process.

The ink recycling system may be implemented on any fabric printer including direct to garment printers and digital roll to roll printers.

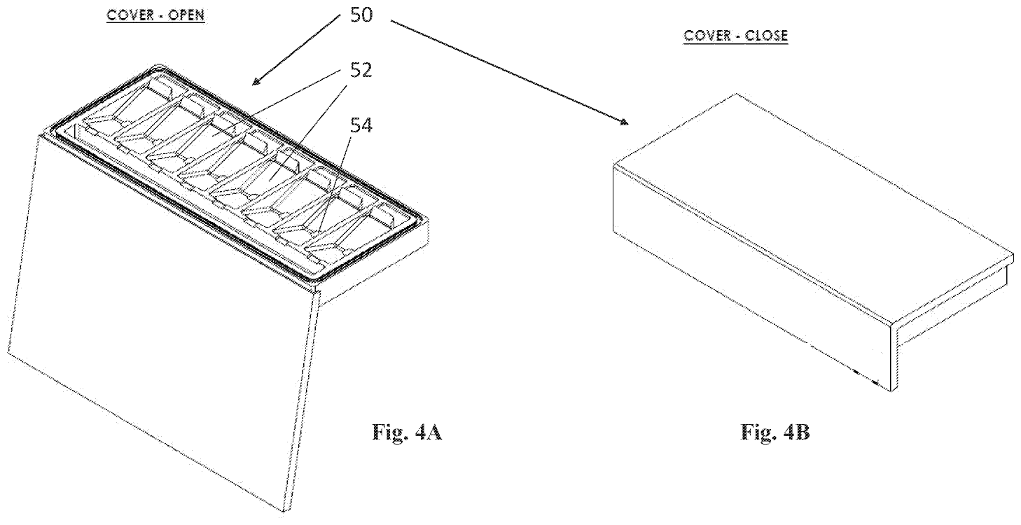

Reference is now made to FIGS. 4A and 4B, which show a possible construction of a collection tray 50 according to embodiments of the present invention. FIG. 4A shows the tray 50 in an open position and FIG. 4B shows a closed configuration. In the open configuration of FIG. 4A, separate drainage troughs 52 can be seen into which the jetted ink is collected. The print head may only use nozzles dedicated to a given color at any one time, so that the heads currently in use may be directed to a particular one of the drainage troughs. Each trough has a drainage hole 54 through which the ink collected may drain into the interior of the printer underneath, thus isolating the ink to be recycled from the external environment.

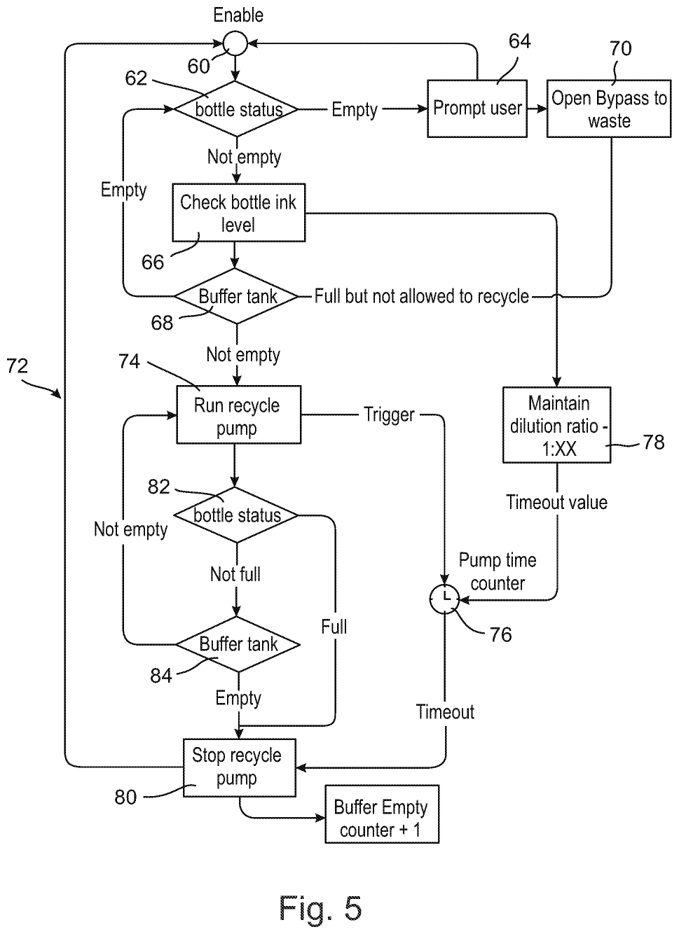

Reference is now made to FIG. 5, which illustrates a simplified flow chart for managing the ink recycling process according to embodiments of the present invention. Upon enablement 60 the ink supply bottle status is checked—62. If the supply is empty then a prompt is issued 64. In 66 the ink level is checked. In 68 the ink level in the buffer tank 48 (FIG. 3) is checked. If the buffer tank is full but elsewhere it has been decided that recycling is not allowed, then the buffer tank is discharged to waste—70.

If the buffer tank is empty then there is no recycling to be done and the flow returns to the beginning. If the buffer tank is not empty, that is to say if it is full or partially full, and recycling is allowed, then the lower cycle 72 of the procedure is entered.

In the lower cycle 72, the recycle pump is turned on 74, and after a timed interval expires 76, which interval would indicate that the dilution ratio is exceeded 78, then the recycle pump is turned off 80. The recycle pump may also be turned off if the main ink supply bottle is full 82 or the buffer tank is empty 84. The recycle pump may be turned on when the buffer tank is not empty and recycling is allowed.

It is expected that during the life of a patent maturing from this application many relevant inks, ink-jet and ink-drop print heads, and nozzle purging and other non-printing operations will be developed and the scopes of the corresponding terms are intended to include all such new technologies a priori.

The terms “comprises”, “comprising”, “includes”, “including”, “having” and their conjugates mean “including but not limited to”.

The term “consisting of means” “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A method of recycling ink used in non-printing nozzle dispensing operations in an ink jet printer, the method comprising:
collecting the ink from the non-printing operation in a collection tray;
draining the ink from the collection tray into a closed cell;
draining the ink from the closed cell;
filtering the ink draining from the closed cell; and
adding the ink back to a main ink supply after said filtering, the main ink supply containing fresh ink.

2. The method of claim 1, wherein a proportion of collected ink to fresh ink in the main ink supply is limited to a predetermined maximum proportion, said adding ink back being suspended when said predetermined maximum proportion is reached.

3. The method of claim 1, wherein said recycling is carried out separately per color, each color being assigned a respectively separate closed cell and said ink being added back to the main ink supply of the respective color.

4. The method of claim 1, comprising carrying out said filtering to remove environmental dirt from said ink being collected.

5. The method of claim 4, wherein said filtering comprises separate coarse and fine filtering on said ink being collected.

6. The method of claim 5, comprising buffering said ink being collected.

7. The method of claim 6, wherein said buffering is carried out between said coarse filtering and said fine filtering.

8. The method of claim 1, wherein said cell is substantially closed to protect said collected ink from environmental contaminants.

9. A method of recycling ink used in non-printing nozzle dispensing operations in an ink jet printer, the method comprising:
collecting the ink from the non-printing operation in a cell of a collection tray;
draining the ink from the cell;
filtering the ink draining from the cell;
adding the collected ink, after said filtering, back to a main ink supply containing fresh ink; and
stopping adding the collected ink back to the main ink supply when a proportion of collected ink to fresh ink reaches a predetermined maximum proportion.

10. The method of claim 9, wherein said recycling is carried out separately per color, each color being assigned a separate cell, said ink being added back to the main ink supply of the respective color, and said stopping when said predetermined level is reached being carried out per color.

11-14. (canceled)

15. The method of claim 9, wherein said cell is substantially closed to protect said collected ink from environmental contaminants.

16. The method of claim 9, further comprising overriding said recycling by redirecting said collected ink and other fluid from said filtering.

17. The method of claim 9, comprising measuring ink in each said main ink supply prior to said non-printing nozzle dispensing operation and at subsequent intervals during said collection, therefrom to calculate a current proportion of collected ink to fresh ink.

18. Apparatus for recycling ink used in non-printing nozzle dispensing operations in an ink jet printer, the apparatus comprising:
a collection tray configured with closed cells configured to collect individual ink colors from said non-printing nozzle dispensing operations;
a filtering system, the cells arranged to drain into the filtering system;
the filtering system arranged to filter the ink per color and return the collected ink to an internal tank for a respective color.

19. The apparatus of claim 18, wherein a base of said collection tray and surfaces of said closed cells are constructed or coated using one or more substances selected to be non-reactive with said ink and/or for aiding fast flow of said collected ink.

20. The apparatus of claim 19, wherein at least one of said substances is one member of the group consisting of polyoxymethylene and polytetrafluoroethylene (PTFE).

21. (canceled)

22. The apparatus of claim 20, wherein said ink collection tray comprises polyoxymethylene and said surfaces of said closed cells are coated with PTFE.

23. The apparatus of claim 18, wherein said filtering system comprises a coarse filter followed by a buffering tank followed by a fine filter.

24. The apparatus of claim 18, further comprising sensors for sensing amounts of ink in said internal tanks.

25. The apparatus of claim 24, comprising a control system configured to control said sensors to measure an initial amount of ink prior to said non-printing operation and to make further measurements at subsequent intervals, the control system configured to use said measurements to limit a proportion of collected ink allowed into each internal tank to a predetermined maximum proportion.

26. The apparatus of claim 18, comprising an override to redirect ink from said non-printing operation being collected.
